(19) United States
(12) Patent Application Publication
(10) Pub. No.: US 2026/0005482 A1
(43) Pub. Date: Jan. 1, 2026

(54) SYSTEM AND METHOD OF A SWIVEL UNIVERSAL SERIAL BUS ADAPTER

(71) Applicant: Dell Products LP, Round Rock, TX (US)

(72) Inventors: Hin Loong Wong, Singapore (SG); Siluvai Micheal Starlin Innasimuthu, Singapore (SG)

(73) Assignee: Dell Products LP, Round Rock, TX (US)

(21) Appl. No.: 18/755,236

(22) Filed: Jun. 26, 2024

(51) Int. Cl. H01R 35/04; H01R 12/72; H01R 12/75; H01R 13/66

(52) U.S. Cl. CPC H01R 35/04; H01R 12/727; H01R 12/75; H01R 13/6658

(57) ABSTRACT

A swivel universal serial bus (USB) adapter includes a USB cable comprising a coaxial cable to transmit power and data between a wired peripheral device and a USB port, a printed circuit board (PCB) to operatively couple with the coaxial cable via a first USB connector formed at a first end of the PCB and a second USB connector formed at a second end of the PCB, a swivel bracket casing, where the swivel bracket casing comprises swivel bracket casing channel and a swivel hinge to pass the coaxial cable through to the PCB, and a first USB/PCB cover and a second USB/PCB cover to enclose the PCB. The swivel USB adapter may be swiveled on the swivel hinge to switch between the first USB connector and the second USB connector.

### FIELD OF THE DISCLOSURE

The present disclosure generally relates to a universal serial bus (USB) adapter for use with information handling systems. The present disclosure more specifically relates to a swivel USB adapter that includes a plurality of USB connectors such as a USB-A and USB-C connector.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be used to execute instructions of one or more workspace productivity applications, or gaming applications or the like. Further, the information handling system be operatively coupled to a peripheral device via a wired connection using a universal serial bus (USB) connector.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system that may be operatively coupled to a peripheral device via a swivel universal serial bus (USB) adapter according to an embodiment of the present disclosure;

FIG. 2 is a graphic diagram illustrating a swivel USB adapter according to a first embodiment of the present disclosure;

FIG. 3A is a graphic diagram of a USB cable for a swivel USB adapter including a coaxial cable interfacing through a first swivel bracket casing of a swivel USB adapter according to an embodiment of the present disclosure;

FIG. 3B is a graphic diagram of the USB cable including the coaxial cable interfacing through the first swivel bracket casing and a second swivel bracket casing of a swivel USB adapter according to an embodiment of the present disclosure;

FIG. 4A is a graphic diagram of the USB cable including the coaxial cable interfacing via the first swivel bracket casing and a second swivel bracket casing with a printed circuit board having a first USB connector and a second USB connector of a swivel USB adapter according to an embodiment of the present disclosure;

FIG. 4B is a graphic diagram of the USB cable including the coaxial cable interfacing via the first swivel bracket casing and a second swivel bracket casing with a printed circuit board having a first USB connector and a second USB connector housed in a second USB/PCB cover of a swivel USB adapter according to an embodiment of the present disclosure;

FIG. 5A is a graphic diagram of the second USB/PCB cover having the first USB connector and second USB connector of a swivel USB adapter according to an embodiment of the present disclosure;

FIG. 5B is a graphic diagram of the first USB/PCB cover and the second USB/PCB cover having the first USB connector and second USB connector of a swivel USB adapter according to an embodiment of the present disclosure;

FIG. 6 is a graphic diagram illustrating a swivel USB adapter according to another embodiment of the present disclosure;

FIG. 7A is a graphic diagram of a USB cable including a coaxial cable interfacing through a first swivel bracket casing of a swivel USB adapter according to another embodiment of the present disclosure;

FIG. 7B is a graphic diagram of the USB cable including the coaxial cable interfacing through the first swivel bracket casing and a second swivel bracket casing of a swivel USB adapter according to another embodiment of the present disclosure;

FIG. 8A is a graphic diagram of the USB cable including the coaxial cable interfacing via the first swivel bracket casing and a second swivel bracket casing with a printed circuit board having a first USB connector and a second USB connector of a swivel USB adapter according to another embodiment of the present disclosure;

FIG. 8B is a graphic diagram of the USB cable including the coaxial cable interfacing via the first swivel bracket casing and a second swivel bracket casing with a printed circuit board having a first USB connector and a second USB connector housed in a second USB/PCB cover of a swivel USB adapter according to another embodiment of the present disclosure;

FIG. 9A is a graphic diagram of the second USB/PCB cover having the first USB connector and second USB connector of a swivel USB adapter according to an embodiment of the present disclosure;

FIG. 9B is a graphic diagram of the first USB/PCB cover and the second USB/PCB cover having the first USB connector and second USB connector of a swivel USB adapter according to an embodiment of the present disclosure; and

FIG. 10 is a circuit diagram of swivel USB adapter circuits according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems may be operatively coupled to a peripheral device that allows the user to interact with the information handling system. These peripheral devices may include a mouse, a keyboard, a video display device, a stylus, a trackpad, and the like that allows a user to provide input to the information handling system and receive output from the information handling system. These peripheral devices may be couplable to the information handling system via a wired connection. These wired couplings include the use of a various universal serial bus (USB) connectors. Information handling systems and peripheral devices have been using USB-A connectors, but have recently been transitioning to USB-C connectors. Indeed, some information handling systems, docking stations, or other systems include both USB-A and USB-C ports to receive USB-A and USB-C connectors. Although some transition is occurring from USB-A to USB-C connectors for wired peripheral devices, there are still legacy information handling systems and/or peripheral devices that operate with USB-A connectors as well as others that operate with USB-C connectors or both.

In order to operate with either legacy information handling systems or peripheral devices that include a USB-A port, a USB-A to USB-C or USB-C to USB-A adapter is needed. Often, these USB-A to USB-C or USB-C to USB-A adapters may be a unibody adapter or may be an adapter including a long and unsightly cabling or leash for the adapter. These unibody USB-A to USB-C or USB-C to USB-A adapters, for example, are quite small lending them to being lost easily by the user when not in use.

In other USB-A to USB-C or USB-C to USB-A adapters, a wired connection may be present between the USB male plug and the USB female port of the adapter requiring a long and unsightly additional cable for the adapter or a leash cable of an adapter to an existing USB connector. Again, however, these type of USB-A to USB-C or USB-C to USB-A adapters may be easily lost if not coupled to their ports or placed within a storage compartment meant to hold the USB-A to USB-C or USB-C to USB-A adapter. Additionally, the USB-A to USB-C or USB-C to USB-A adapters with the wired connection between the USB male plug and the USB female port is unsightly with additional cabling or leash cable which may be undesirable and lead to low usage by the user.

In still other USB-A to USB-C or USB-C to USB-A adapters, a flexi-coupled USB-A to USB-C or USB-C to USB-A adapter may be operatively coupled via a leash cable to the main USB cable to prevent loss of the adapter by the user. However, these types of adapters are also unsightly leading to low usage and when not in use and be undesirable since they may dangle off to the side of the USB cable and clutter the side of the information handling system or peripheral device.

Embodiments of the present specification describe a swivel universal serial bus (USB) adapter that includes a USB cable comprising a coaxial cable to transmit power and data between a wired peripheral device and a USB port. The swivel USB adapter includes a printed circuit board (PCB) to operatively couple the coaxial cable to a first USB connector formed at a first end of the PCB and a second USB connector formed at a second end of the PCB in an embodiment. In an embodiment, the PCB includes a PCB cutout to pass the coaxial cable out of a swivel hinge and to the PCB. The swivel USB adapter may also include a swivel bracket casing with the swivel bracket casing comprising swivel bracket casing channel and the swivel hinge to pass the coaxial cable through to the PCB via the PCB cutout. In an embodiment, the swivel USB adapter includes a first USB/PCB cover and a second USB/PCB cover to enclose the PCB. The first and second USB/PCB cover may also be used by the user to manipulate the swiveling USB adapter to swivel the swivel USB adapter from the first USB connector to the second USB connector or visa-versa where the first USB adapter or second USB adapter is to be used to operatively couple a wired peripheral device to the information handling system.

In an embodiment, the first USB connector is a USB-A connector. In an embodiment, the second USB connector is a USB-C connector. In other embodiments, the first USB connector may be any type of USB connector and the second USB connector may be any other type of connector with the types selected from a USB Standard-A connector, a USB Standard-B connector, a USB Mini-A connector, a USB Mini-AB connector, a USB Mini-B connector, a USB Micro-A connector, a USB Micro-AB connector, a USB Micro-B connector, USB Type-C, among others.

In an embodiment, the swivel USB adapter includes one or more rotation limiter ribs formed on the first or second USB/PCB cover to interact with a rotation limiter hinge wheel formed on the swivel bracket casing to limit the rotation of the PCB with the first USB connector formed at a first end of the PCB and a second USB connector formed at a second end of the PCB from rotating more than 180° about the swivel hinge in a single direction. These limiter ribs prevent the user from rotating the internal PCB significantly too far beyond 180 degrees such that the coaxial cables are stressed or even torn from the PCB.

In an embodiment, the swivel USB adapter includes one or more hemispherical holes or cavities formed on the first or second USB/PCB cover to engage with hemispherical bumps formed on the swivel bracket casing to lock the PCB with the first USB connector and second USB connector in a 180° orientation and provide haptic feedback to a user of the swivel USB adapter indicating that the PCB with the first USB connector and second USB connector is locked in a first or second 180° orientation when swiveled. This allows the user to feel when the swivel USB adapter has been switched and locked into a parallel configuration with the swivel bracket casing for use of either the first USB connector or the second USB connector.

In an embodiment, the PCB may include electrical circuits that serve to transmit data and power between a peripheral device and an information handling system or other devices being operatively coupled using a USB cable having the swivel USB adapter. In an embodiment, the PCB includes electrical circuit connections that pass the USB lines of the coaxial cable between the first USB connector and second USB connector to prevent the functional operation of both the first USB connector and second USB connector at the same time since doing so will prevent either USB connector from operating.

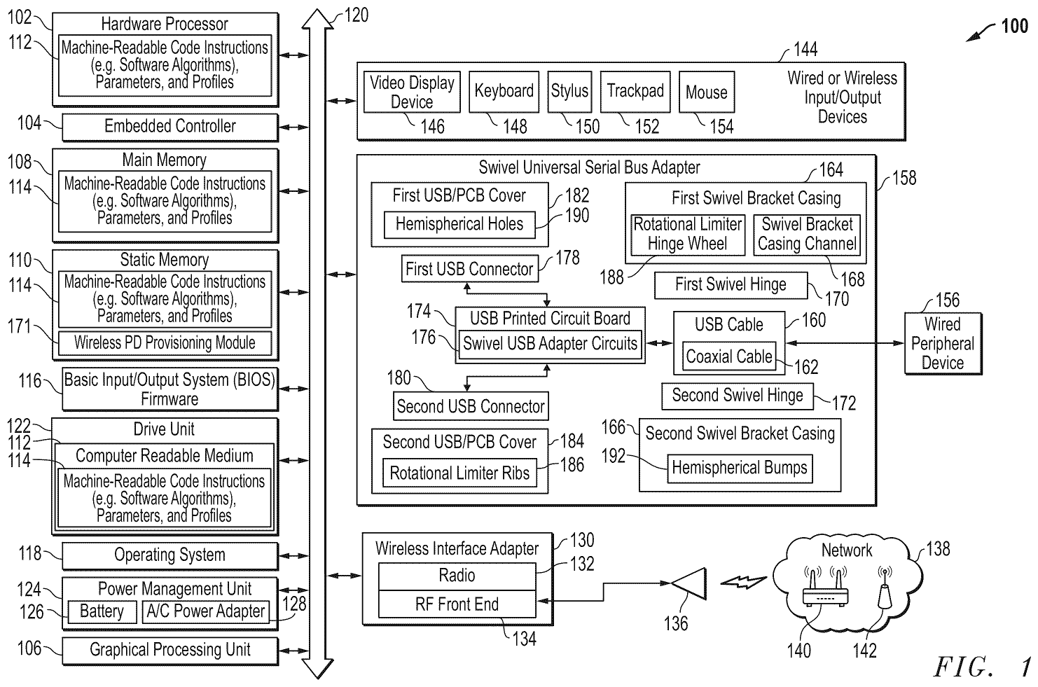

Turning now to the figures, FIG. 1 illustrates an information handling system 100 similar to the information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 140, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of instructions to perform one or more computer functions.

The information handling system 100 may include main memory 108, (volatile (e.g., random-access memory, etc.), or static memory 110, nonvolatile (read-only memory, flash memory etc.) or any combination thereof), one or more hardware processing resources, such as a hardware processor 102 that may be a central processing unit (CPU), embedded controller (EC) 104, a graphics processing unit (GPU) 106, or any combination thereof. Additional components of the information handling system 100 may include one or more storage devices such as static memory 110 or drive unit 122. The information handling system 100 may include or interface with one or more communications ports for communicating with external devices, as well as various input and output (I/O) devices 144, such as a mouse 154, a trackpad 152, a stylus 150, a keyboard 148, a video/graphics display device 146, the wired peripheral device 156 described herein, or any combination thereof. Portions of an information handling system 100 may themselves be considered information handling systems 100.

Information handling system 100 may include devices or modules that embody one or more of the devices or execute instructions for one or more systems and modules. The information handling system 100 may execute instructions (e.g., software algorithms), parameters, and profiles 114 that may operate on servers or systems, remote data centers, or on-box in individual client information handling systems according to various embodiments herein. In some embodiments, it is understood any or all portions of instructions (e.g., software algorithms), parameters, and profiles 114 may operate on a plurality of information handling systems 100.

The information handling system 100 may include the hardware processor 102 such as a central processing unit (CPU) or other hardware processing resources. Any of the hardware processing resources may operate to execute code that is either firmware or software code. Moreover, the information handling system 100 may include memory such as main memory 108, static memory 110, and disk drive unit 122 (volatile (e.g., random-access memory, etc.), nonvolatile memory (read-only memory, flash memory etc.) or any combination thereof or other memory with computer readable medium 112 storing instructions (e.g., software algorithms), parameters, and profiles 114 executable by the hardware processor 102, EC 104, GPU 106, or any other hardware processing device. The information handling system 100 may also include one or more buses 120 operable to transmit communications between the various hardware components such as any combination of various I/O devices 144 as well as between hardware processors 102, an EC 104, the operating system (OS) 118, the basic input/output system (BIOS) 116, the wireless interface adapter 130, or a radio module, among other components described herein. The buses 120 may include connectivity to ports such as a USB port or other port for use with the swivel USB adapter 158 of embodiments herein. In an embodiment, the hardware processor 102, EC 104, and/or GPU 106 may execute one or more bus drivers in order to transmit this data between the information handling system 100 and the input/output devices 144 described herein. In an embodiment, the information handling system 100 may be in wired or wireless communication with the I/O devices 144 such a keyboard 148, a mouse 154, video display device 146, stylus 150, trackpad 152, among other peripheral devices. As described in embodiments herein, the information handling system 100 is in wired communication with the wired peripheral device 156 via the swivel USB adapter 158.

As described herein, the information handling system 100 further includes a video/graphics display device 146. The video/graphics display device 146 in an embodiment may function as a liquid crystal display (LCD), an organic light emitting diode (OLED), a flat panel display, or a solid-state display. It is appreciated that the video/graphics display device 146 may be wired or wireless and may be an external video/graphics display device 146 that allows a user to increase the desktop area by extending the desktop in an embodiment. Additionally, as described herein, the information handling system 100 may include or be operatively coupled to a cursor control device (e.g., a trackpad 152, or gesture or touch screen input), a stylus 150, and/or a keyboard 148, among others that allows the user to interface with the information handling system 100 via the video/graphics display device 146. Information handling system 100 may also be operatively coupled to a wired or wireless input/output device 144 such as the wireless peripheral device 156 or other hardware devices that may include a hardware processing device such as a hardware processor, microcontroller, or other hardware processing resource. Various drivers and hardware control device electronics may be operatively coupled to operate the I/O devices 144 according to the embodiments described herein. The present specification contemplates that the I/O devices 144 may be wired or wireless.

A network interface device of the information handling system 100 may be wired or wireless such as shown with wireless interface adapter 130 that can provide wireless connectivity among devices such as with Bluetooth® or to a network 138, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 132, RF front end 134 and antenna 136 is used to communicate with the wireless peripheral devices including the wireless peripheral device 156 described herein, via, for example, a Bluetooth® or Bluetooth® Low Energy (BLE) protocols or any proprietary RF protocol such as those may utilize similar frequency ranges but proprietary modulation and data transmission characteristics. In embodiments, Bluetooth®, BLE, proprietary RF protocol, or other WPAN or WLAN protocols and plural such protocols may be used for communication with and among a wireless peripheral device 156 or any other wireless peripheral device to be paired with the information handling system 100 or other information handling systems.

In other embodiments, a WAN, WWAN, LAN, and WLAN may each include an AP 140 or base station 142 used to operatively couple the information handling system 100 to a network 138 via a wireless interface adapter 130. In a specific embodiment, the network 138 may include macro-cellular connections via one or more base stations 142 or a wireless AP 140 (e.g., Wi-Fi), or such as through licensed or unlicensed WWAN small cell base stations 142. Connectivity may be via wired or wireless connection. For example, wireless network wireless APs 140 or base stations 142 may be operatively connected to the information handling system 100. Wireless interface adapter 130 may include one or more RF (RF) subsystems (e.g., radio 132) with transmitter/receiver circuitry, modem circuitry, one or more antenna RF (RF) front end circuits 134, one or more wireless controller circuits, amplifiers, antennas 136 and other circuitry of the radio 132 such as one or more antenna ports used for wireless communications via multiple radio access technologies (RATs). The radio 132 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WWAN such as 3GPP or 3GPP2, Bluetooth® standards, proprietary RF protocol, or similar wireless standards may be used. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system 100 or integrated with another wireless network interface capability, or any combination thereof.

In some embodiments, software, firmware, dedicated hardware implementations such as application specific integrated circuits, programmable logic arrays and other hardware devices may be constructed to implement one or more of some systems and methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a hardware controller or a hardware processor system. Further, in an exemplary, non-limited embodiment, implementations may include distributed hardware processing, component/object distributed hardware processing, and parallel hardware processing. Alternatively, virtual computer system processing may be constructed to implement one or more of the methods or functionalities as described herein.

The present disclosure contemplates a computer-readable medium that includes computer-readable code instructions, parameters, and profiles 114 or receives and executes instructions, parameters, and profiles 114 responsive to a propagated signal, so that a hardware device connected to a network 138 may communicate voice, video, or data over the network 138. Further, the instructions 114 may be transmitted or received over the network 138 via the network interface device or wireless interface adapter 130.

The information handling system 100 may include a set of instructions 114 that may be executed to cause the computer system to perform any one or more of the methods or computer-based functions disclosed herein. For example, instructions 114 may be executed by a hardware processor 102, GPU 106, EC 104 or any other hardware processing resource and may include software agents, or other aspects or components used to execute the methods and systems described herein. Various software modules comprising application instructions 114 may be coordinated by an OS 118, and/or via an application programming interface (API) include a unified device API described herein. An example OS 118 may include Windows®, Android®, and other OS types. Example APIs may include Win 32, Core Java API, or Android APIs. In an embodiment, the set of instructions 114 executed by a hardware processor 102 may include drivers associated with the operation and interfacing between the wired peripheral device 156 and the information handling system 100.

In an embodiment, the information handling system 100 may include a disk drive unit 122. The disk drive unit 122 and may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106 or EC 104, or other microcontroller unit to perform the processes described herein. Similarly, main memory 108 and static memory 110 may also contain a computer-readable medium for storage of one or more sets of machine-readable code instructions, parameters, or profiles 114 described herein. The disk drive unit 122 or static memory 110 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 108, the static memory 110, and/or within the disk drive 122 during execution by the hardware processor 102, EC 104, or GPU 106 of information handling system 100.

Main memory 108 or other memory of the embodiments described herein may contain computer-readable medium (not shown), such as RAM in an example embodiment. An example of main memory 108 includes random access memory (RAM) such as static RAM (SRAM), dynamic RAM (DRAM), non-volatile RAM (NV-RAM), or the like, read only memory (ROM), another type of memory, or a combination thereof. Static memory 110 may contain computer-readable medium (not shown), such as NOR or NAND flash memory in some example embodiments. The applications and associated APIs, for example, may be stored in static memory 110 or on the disk drive unit 122 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 124 (a.k.a. a power supply unit (PSU)). The PMU 124 may include a hardware controller and executable machine-readable code instructions to manage the power provided to the components of the information handling system 100 such as the hardware processor 102 and other hardware components described herein. The PMU 124 may control power to one or more components including the one or more drive units 122, the hardware processor 102 (e.g., CPU), the EC 104, the GPU 106 and other information handling system components that may require power when a power button has been actuated by a user. Further, the PMU 124 may control power to one or more external components such as a video/graphic display device 146, or other wired I/O devices 144 such as the mouse 154, the stylus 150, the keyboard 148, and the trackpad 152 via a port and connectors such USB connectors that may use the swivel USB adapter 158 of embodiments herein to supply power as well as data. In an embodiment, the PMU 124 may monitor power levels and be electrically coupled to the information handling system 100 to provide this power. The PMU 124 may be coupled to the bus 120 to provide or receive data or machine-readable code instructions. The PMU 124 may regulate power from a power source such as the battery 126 or AC power adapter 128. In an embodiment, the battery 126 may be charged via the AC power adapter 128 and provide power to the components of the information handling system 100, via wired connections as applicable, or when AC power from the AC power adapter 128 is removed. In an embodiment, the PMU 124 may also regulate power provided to the wired peripheral device 156 via a USB port into which the wired peripheral device 156 is plugged into via use of the swivel USB adapter 158 described herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 110 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

As described in embodiments of the present disclosure, a wired peripheral device 156 or other devices may be operatively coupled with the information handling system 100 via a swivel universal serial bus (USB) adapter 158. The swivel USB adapter 158 may include, in an example embodiment, two different USB connectors that allow for the user to operatively couple the wired peripheral device 156 to the information handling system 100 using either of the two different USB connectors. The swivel universal serial bus adapter 158 may be operatively coupled to the information handling system 100 using any of a first USB connector 178 or second USB connector 180 to operatively couple the wired peripheral device 156 to the information handling system 100 via a wired connection. Additionally, or alternatively, the swivel universal serial bus adapter 158 may be used to operatively couple the information handling system 100 to the wired peripheral device 156 using one of the first USB connector 178 or second USB connector 180. In an embodiment, therefore, the swivel universal serial bus adapter 158 may be formed on a first end of a USB cable 160, a second end of the USB cable 160, or both in order to operatively coupled the wired peripheral device 156 or other device to the information handling system 100 via a wired connection. The present specification, therefore, contemplates that the swivel universal serial bus adapter 158 may be used on any USB cable 160 and at any end of the USB cable 160. In many embodiments, the swivel universal serial bus adapter 158 is on a cable from a wired peripheral device 156 to be plugged into a female connector port at the information handling system 100, a docking station, or other device where the female connector port is of either type of USB connector.

In an embodiment, the swivel universal serial bus adapter 158 includes a USB cable 160 that has any number of coaxial cables 162 formed in the USB cable 160. In an example embodiment, the USB cable 160 may include a plurality of coaxial cables 162 that provide for both power and data transmissions over the coaxial cables 162 to provide power to the wired peripheral device 156 as well as transmit between the wired peripheral device 156 and the information handling system 100. In an embodiment, these coaxial cables 162 may include a power (Vbus) cable, a first data cable (D−), a second data cable (D+), and a ground cable. It is appreciated that other cables may be provided, and the present specification contemplates the use of additional coaxial cables in the USB cable 160.

The swivel universal serial bus adapter 158 further includes a first swivel bracket casing 164 operatively coupled to the USB cable 160. The first swivel bracket casing 164 may be made of a plastic in an example embodiment. It is appreciated that the first swivel bracket casing 164 may be made of any rigid material such as plastic or a metal. The first swivel bracket casing 164 may, generally, have a U-shape with a first swivel hinge 170 at one arm of the U-shape and a second swivel hinge 172 formed at the other arm of the U-shape. In an embodiment, the first swivel bracket casing 164 is operatively coupled to the USB cable 160 via a cable lip that interfaces with the housing of the first swivel bracket casing 164 to secure the USB cable 160 to the first swivel bracket casing 164. In an embodiment, the first swivel bracket casing 164 includes a swivel bracket casing channel 168. The swivel bracket casing channel 168 is formed as a space within the first swivel bracket casing 164 for the coaxial cables 162 of the USB cable 160 to pass through one of the U-shaped arms of the first swivel bracket casing 164 and out of a first swivel hinge 170 or second swivel hinge 172 formed on the first swivel bracket casing 164. It is appreciated that the swivel bracket casing channel 168 may be formed into any of the two U-shaped arms of the first swivel bracket casing 164 and that the coaxial cable 162 may be passed through either of the corresponding first swivel hinge 170 or second swivel hinge 172. In other embodiments it is appreciated that the swivel bracket casing channel 168 may be formed into the first swivel bracket casing 164, a second swivel bracket casing 166, or some combination such that the coaxial cable 162 is enclosed within the swivel bracket case formed by the first swivel bracket casing 164 and the second swivel bracket casing 166.

In an embodiment, the coaxial cable 162 is operatively coupled to a universal serial bus (USB) printed circuit board (PCB) 174. The USB PCB 174 may be formed to fit within the U-shaped first swivel bracket casing 164. The USB PCB 174 serves to provide a surface onto which swivel USB adapter circuits 176 may be formed for the coaxial cables 162 to be operatively coupled to a first USB connector 178 as well as a second USB connector 180. In the embodiments herein, the swivel USB adapter circuits 176 formed on the USB PCB 174 operatively couple the coaxial cables 162 to a first USB connector 178 formed at a first end of the USB PCB 174 and a second USB connector 180 formed at a second end of the USB PCB 174. In an embodiment, a halfway distance from the first USB connector 178 and the second USB connector 180 along the USB PCB 174 is the location where the USB PCB 174 is swiveled from the first USB connector 178 being swiveled forward for use and the second USB connector 180 being swived forward for use.

In one embodiment, the first USB connector 178 is a USB-A connector. In an embodiment, the second USB connector 180 is a USB-C connector. In an embodiment, the first USB connector 178 may be any type of USB connector and the second USB connector 180 may be any other type of connector selected from a USB Standard-A connector, a USB Standard-B connector, a USB Mini-A connector, a USB Mini-AB connector, a USB Mini-B connector, a USB Micro-A connector, a USB Micro-AB connector, a USB Micro-B connector, USB Type-C connector, among others.

In an embodiment, the swivel universal serial bus adapter 158 includes a second swivel bracket casing 166 that interfaces with the first swivel bracket casing 164 to enclose the coaxial cable 162 within the swivel bracket casing channel 168. The second swivel bracket casing 166 may be made of a plastic in an example embodiment. It is appreciated that the second swivel bracket casing 166 may be made of any rigid material such as plastic or a metal. In an embodiment, the first swivel bracket casing 164 and second swivel bracket casing 166 may be coupled together using a snap fit system, any fastening device, plastic or other welding technique, or adhesive. In an embodiment, the first swivel bracket casing 164 and second swivel bracket casing 166 may be coupled together using a welding process including ultrasonic welding.

In an embodiment, the USB PCB 174, coaxial cables 162, first USB connector 178, and second USB connector 180 may also be housed in a USB/PCB cover. In an embodiment, the USB/PCB cover may include a first USB/PCB cover 182 and a second USB/PCB cover 184. The first USB/PCB cover 182 and second USB/PCB cover 184, in an embodiment, may be made of a plastic. In an embodiment, the first USB/PCB cover 182 and second USB/PCB cover 184 may be made of any rigid material such as plastic or a metal. Similar to the first swivel bracket casing 164 and second swivel bracket casing 166, the first USB/PCB cover 182 and second USB/PCB cover 184 may be operatively coupled together using a snap fit system, any fastener, a weld process, or adhesive. In an embodiment, the first USB/PCB cover 182 and second USB/PCB cover 184 may be operatively coupled together using a welding process including an ultrasonic welding process.

In an embodiment, the first swivel bracket casing 164 or second swivel bracket casing 166 may include a rotational limiter hinge wheel 188. Additionally, the first USB/PCB cover 182 or second USB/PCB cover 184 may include one or more rotational limiter ribs 186 that interface with the rotational limiter hinge wheel 188 to prevent over rotation of the USB PCB 174 within the first swivel bracket casing 164 and second swivel bracket casing 166. In an embodiment, the rotational limiter hinge wheel 188 may be sized and the placement of the rotational limiter ribs 186 may be selected to prevent the assembly parts including the USB PCB 174, first USB connector 178, second USB connector 180, first USB/PCB cover 182, and second USB/PCB cover 184 from being rotated more than 180° in either a first rotational direction or a second rotational direction. It is appreciated that this limiter may allow for some additional rotation above 180° in either or both rotation directions since the tactile locking system may hold the swivel USB adapter 158 at the 180° rotation position. In another embodiment, the rotational limiter hinge wheel 188 may be formed onto the housing formed by the first USB/PCB cover 182 and second USB/PCB cover 184 while the rotational limiter ribs 186 are formed at one of the first swivel hinge 170 or second swivel hinge 172 to interface with that rotational limiter hinge wheel 188.

In an embodiment, the swivel universal serial bus adapter 158 may include hemispherical holes 190 to that interface with hemispherical bumps 192 in order to lock the orientation of the USB PCB 174, first USB/PCB cover 182, second USB/PCB cover 184 assembly in place relative to the first swivel bracket casing 164 and second swivel bracket casing 166 assembly. In an embodiment, either or a combination of both of the first USB/PCB cover 182 or second USB/PCB cover 184 may include the hemispherical holes 190 which may be a cavity formed into the first and second USB/PCB covers 182 and 184. The corresponding hemispherical bumps 192 are formed on either of the first swivel bracket casing 164 or swivel bracket casing channel 168. It is also appreciated that, in an alternative embodiment, the hemispherical bumps 192 may be formed onto a surface of either the first USB/PCB cover 182 or second USB/PCB cover 184 while the hemispherical holes 190 are formed into either of the first swivel bracket casing 164 or second swivel bracket casing 166. During operation and when a user rotates or swivels the USB PCB 174, first USB/PCB cover 182, and second USB/PCB cover 184 assembly, the hemispherical bumps 192 may be forced into the hemispherical holes 190 in order to provide tactile feedback and hold the USB PCB 174, first USB connector 178, and second USB connector 180 assembly in place in a swivel position. This locking may also provide haptic feedback to the user indicating that the USB PCB 174, first USB connector 178, and second USB connector 180 assembly is locked into place in either a first or second 180 degree swivel position.

As described herein, the swivel universal serial bus adapter 158 allows for a single device that supports operatively coupling of a wired peripheral device 156 or other device to an information handling system 100, docking station, or other device using either of a first USB connector 178 or a second USB connector 180 depending on the type of corresponding USB port available at the information handling system 100, docking station, or at the wired peripheral device 156. The locking of the swivel universal serial bus adapter 158 through the use of the hemispherical holes 190 and hemispherical bumps 192 also allows for tactile feedback for swiveling into position and ease of connection of the swivel universal serial bus adapter 158 to a USB port at the information handling system 100 or wired peripheral device 156 by the user. Still further, because the swivel universal serial bus adapter 158 does not include any loose USB adapters, the adapters are less likely to be lost by the user such as when part of the wired peripheral device 156 thereby increasing user satisfaction and use of the swivel universal serial bus adapter 158.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

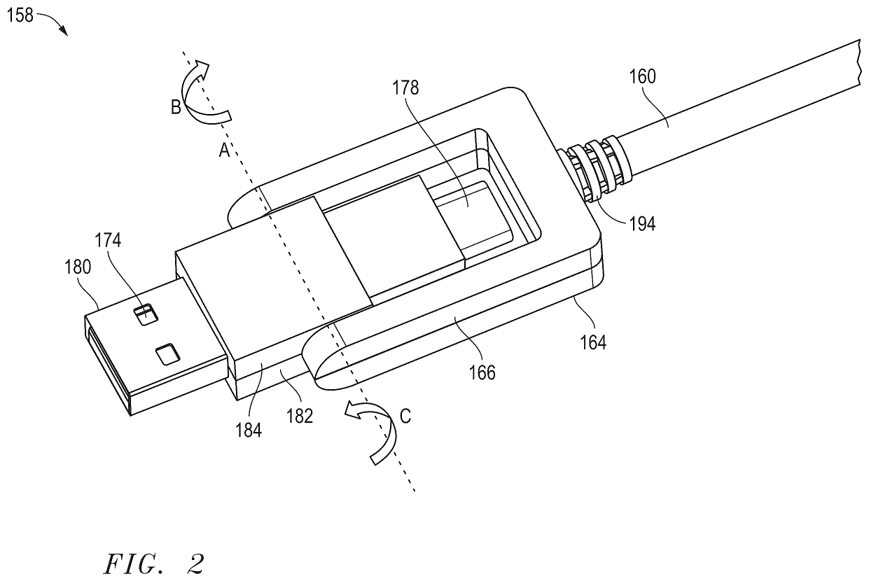

FIG. 2 is a graphic diagram illustrating a swivel USB adapter 158 according to a first embodiment of the present disclosure. In an embodiment, the wired peripheral device 156 shown in FIG. 2 may be similar to the wired peripheral device described in connection with FIG. 1. As described herein, the swivel USB adapter 158 may be operatively coupled to a terminal end of a USB cable 160. The USB cable 160 may be directly coupled to a wired peripheral device (not shown) in an embodiment. In another embodiment, the USB cable 160 may include another swivel USB adapter 158 formed at another end of the USB cable 160 such that a first swivel USB adapter 158 is formed at a first end of the USB cable 160 and a second swivel USB adapter 158 is formed at a second end of the USB cable 160.

The USB cable 160 may include one or more USB cable ribs 194 formed as part of a cable jacket for the USB coaxial cable 160. In an embodiment, these USB cable ribs 194 may be used to provide material support to the USB cable 160 such that constant bending of the USB cable 160 at these USB cable ribs 194 does not damage the coaxial cables within the cable jacket of the USB cable 160 are not damaged. Additionally, as described herein, one end portion of the USB cable ribs 194 may be used to interface, mechanically, with the first swivel bracket casing 164 and second swivel bracket casing 166 to secure the USB cable 160 to the swivel USB adapter 158 as well as protect an end of the coaxial USB cable 160 terminating at the first and second swivel bracket casings 164, 166. In an embodiment, a portion of the USB cable rib 194 may be placed within a hole formed in the first swivel bracket casing 164 and second swivel bracket casing 166 such that the USB cable 160 cannot be pulled out from the first swivel bracket casing 164 and second swivel bracket casing 166.

FIG. 2 also shows a first USB/PCB cover 182 and second USB/PCB cover 184 that form a USB/PCB housing that houses a USB PCB 174 with its swivel USB adapter circuits (not shown) as well as portions of the first USB connector 178 and second USB connector 180. As described herein, either of the first USB/PCB cover 182 or second USB/PCB cover 184 may include hemispherical holes or cavities (not shown) formed into a side surface of the either the first USB/PCB cover 182 or second USB/PCB cover 184. These hemispherical holes or cavities may interface with one or more hemispherical bumps (not shown) formed on an interior surface of either the first swivel bracket casing 164 or second swivel bracket casing 166. Again, during operation and when a user rotates or swivels the USB PCB 174, first USB/PCB cover 182, and second USB/PCB cover 184 assembly, the hemispherical bumps may be forced into the hemispherical cavities in order to lock the USB PCB 174, first USB connector 178, and second USB connector 180 assembly in place in a first or second position for use of either the first USB connector 178 or the second USB connector 180. This locking may also provide haptic feedback to the user indicating that the USB PCB 174, first USB connector 178, and second USB connector 180 assembly is locked into place.

FIG. 2 shows that two different USB connectors have been implemented in this example embodiment. In the example shown in FIG. 2, the first USB connector 178 is shown as a USB-C type male connector used to operatively couple a wired peripheral device or the USB cable 160 into a USB-C type port on a wired peripheral device or information handling system. Additionally, FIG. 2 shows the second USB connector 180 is a USB-A type male connector used to operatively couple a wired peripheral device or the USB cable 160 into a USB-A port on a wired peripheral device or information handling system. It is appreciated, however, that the first USB connector 178 may be any type of USB connector and the second USB connector 180 may be any type of connector such as a USB Standard-A connector, a USB Standard-B connector, a USB Mini-A connector, a USB Mini-AB connector, a USB Mini-B connector, a USB Micro-A connector, a USB Micro-AB connector, a USB Micro-B connector, USB Type-C, among others. Further, it is contemplated that the first USB connector 178, the second USB connector 180, or both may be female type USB connectors in other embodiments. The swivel USB adapter 158 may, therefore, provide for a plurality of different types of USB connectors being used as the first USB connector 178 and second USB connector 180 that may span over a technology transition period from a first USB type of connector to a second USB type of connector.

FIG. 2 also shows potential directions of rotation (e.g., arrow “B” and arrow “C”) and an axis on which the assembly of the USB PCB 174, first USB/PCB cover 182, and second USB/PCB cover 184 may swivel or rotate about. For example, the user may rotate, about the axis “A,” the assembly of the USB PCB 174, first USB/PCB cover 182, and second USB/PCB cover 184 in direction “B” to cause the first USB connector 178 to face forward thereby swapping locations with the second USB connector 180. With the first USB connector 178 in its new position, the user may rotate, about the axis “A,” the assembly of the USB PCB 174, first USB/PCB cover 182, and second USB/PCB cover 184 in direction “C” to return the second USB connector 180 to its original position.

As described herein, the coaxial cables (not shown) extending from the cable jacket of the USB cable 160 through the first and second swivel bracket casings 164, 166 are operatively coupled to the USB PCB 174. However, over rotation of the USB PCB 174 in a single rotation direction multiple times (e.g., arrow “B” or “C”) may cause the coaxial cable to be torn from those connections to the USB PCB 174. In order to prevent this, in an embodiment, one of the first swivel hinge (not shown) or second swivel hinge (not shown) formed at an interface of the first and second swivel bracket casings 164, 166 and the USB/PCB housing formed by 182,184 may include a rotational limiter hinge wheel (not shown) that interacts with one or more rotational limiter ribs (not shown) formed within the USB/PCB housing (e.g., the first USB/PCB cover 182 and second USB/PCB cover 184). The interaction between the rotational limiter hinge wheel and one or more rotational limiter ribs may allow for a 180° swivel or a 180°+/− and additional degree of rotation (e.g., 2-10 additional degrees of rotation in example embodiments) for swivel of the assembly of the USB PCB 174, first USB/PCB cover 182, and second USB/PCB cover 184 relative to first and second swivel bracket casings 164, 166 in order to prevent the over rotation described herein.

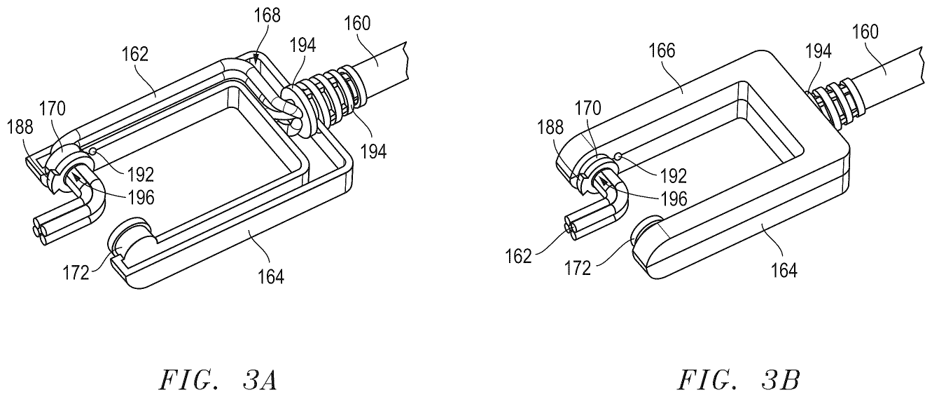

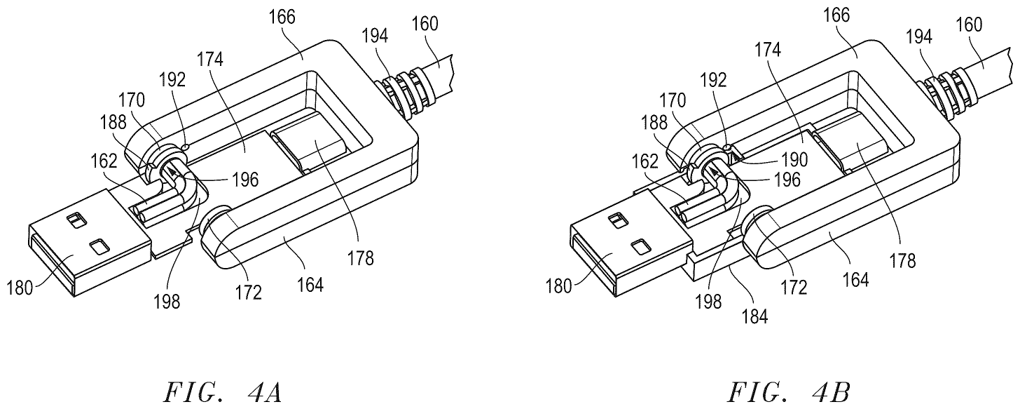

FIGS. 3A, 3B, 4A, and 4B each show portions of a swivel USB adapter 158 described in various embodiments herein. FIG. 3A is a graphic diagram of a USB cable 160 including a cable jacket with cable ribbing 194 and a coaxial cable 162 interfacing with a first swivel bracket casing 164 of a swivel USB adapter 158 according to an embodiment of the present disclosure. Additionally, FIG. 3B is a graphic diagram of the USB cable 160 including the coaxial cable 162 interfacing with the first swivel bracket casing 164 and a second swivel bracket casing 166 of a swivel USB adapter 158 according to an embodiment of the present disclosure. Further, FIG. 4A is a graphic diagram of the USB cable 160 including the coaxial cable 162 interfacing with the first swivel bracket casing 164 and a second swivel bracket casing 166 with a USB PCB 174 having a first USB connector 178 and a second USB connector 180 of a swivel USB adapter 158 according to an embodiment of the present disclosure. Still further, FIG. 4B is a graphic diagram of the USB cable 160 including the coaxial cable 162 interfacing with the first swivel bracket casing 164 and a second swivel bracket casing 166 with a USB PCB 174 having a first USB connector 178 and a second USB connector 180 housed in a second USB/PCB cover 184 of a swivel USB adapter 158 according to an embodiment of the present disclosure.

Turning to FIG. 3A, FIG. 3A shows an operative coupling of the USB cable 160 to the first swivel bracket casing 164. As described herein, the USB cable 160 may include one or more USB cable ribs 194 of a cable jacket for the USB cable 160. In the embodiment shown in FIG. 3, an outer surface of the first swivel bracket casing 164 may include a hole through which a first rib of the USB cable ribs 194 may be inserted or positioned such that the first rib is a larger dimension than the hole formed in the first swivel bracket casing 164 and a second swivel bracket casing (not shown). In this way, the USB cable 160 is affixed, mechanically, to the first swivel bracket casing 164 via at least one rib of the USB cable ribs 194 of the cable jacket. Thus, the inclusion of the USB cable ribs 194 provides both a physical structural support to the USB cable 160 at the location where the USB cable 160 may be most bent to protect the cable jacket and coaxial cable 162 of the USB cable as well as a physical structure to secure the USB cable 160 to the first swivel bracket casing 164 and the second swivel bracket casing 166 as shown in FIG. 3B.

As shown in FIG. 3A, the coaxial cable 162 of the USB cable 160 may be routed through a swivel bracket casing channel 168 formed within the first swivel bracket casing 164. The swivel bracket casing channel 168 may be routed along one of the arms of the U-shaped first swivel bracket casing 164 and out of a coaxial cable via 196 formed at the first swivel hinge 170 of the first swivel bracket casing 164. It is appreciated, however, that the coaxial cable 162 may be routed through the other arm of the U-shaped first swivel bracket casing 164 and out of a coaxial cable via formed at the second swivel hinge 172 instead or in addition in other embodiments.

FIGS. 3A and 3B also show a hemispherical bump 192 formed on an internal surface of the first arm of the U-shaped first swivel bracket casing 164. It is appreciated that the hemispherical bump or another hemispherical bump may be formed on the interior surface of the second arm of the first swivel bracket casing 164 in other embodiments. Alternatively, the hemispherical bumps 192 may be formed on an internal surface of the first arm of the U-shaped second swivel bracket casing 166 and or on an internal surface of the second arm of the U-shaped second swivel bracket casing 166.

FIGS. 3A and 3B both show a rotational limiter hinge wheel 188 formed on the first swivel hinge 170. It is appreciated that, additionally or alternatively, the rotational limiter hinge wheel 188 may be formed on the second swivel hinge 172 in some embodiments. As described herein, the rotational limiter hinge wheel 188 may interface with one or more rotational limiter ribs (not shown) formed into an interior surface of the first USB/PCB cover 182 and/or second USB/PCB cover 184 to limit the degree or rotation of the USB PCB (not shown). In an embodiment, the rotational limiter hinge wheel 188 may be sized and the placement of the rotational limiter ribs may be selected to prevent the assembled parts including the USB PCB, first USB connector (not shown), second USB connector (not shown), first USB/PCB cover (not shown), and second USB/PCB cover (not shown) from being rotated more than 180° or 180° plus some additional rotation amount (e.g. an additional 1° to) 10° in either a first rotational direction (e.g., arrow “B,” FIG. 2) or a second rotational direction (e.g., arrow “C,” FIG. 2). It is appreciated that in another embodiment, the rotational limiter hinge wheel 188 may be formed onto the housing formed by the first USB/PCB cover and second USB/PCB cover while the rotational limiter ribs are formed at one of the first swivel hinge 170 or second swivel hinge 172 to interface with that rotational limiter hinge wheel.

Turning to FIG. 3B, the second swivel bracket casing 166 is shown to be operatively coupled to the first swivel bracket casing 164 thereby forming a swivel bracket housing used to securely house the coaxial cables 162. In an embodiment, the second swivel bracket casing 166 may also include a swivel bracket casing channel 168 that mirrors the swivel bracket casing channel 168 formed into the first swivel bracket casing 164 shown in FIG. 3B to accommodate the placement of the coaxial cables 162 being passed through the first arm of the U-shaped swivel bracket housing. In some embodiments, the first arm of the swivel bracket casing having the swivel bracket casing channel 168 may be wider than the second arm of the swivel bracket casing to save room or width of the overall swivel USB adapter.

By coupling the second swivel bracket casing 166 to the first swivel bracket casing 164, the housing of the first swivel bracket casing 164 and second swivel bracket casing 166 secure the USB cable 160 to the housing of the swivel bracket housing such that the USB cable 160 cannot be pulled from the swivel bracket housing. As described herein, the second swivel bracket casing 166 may be operatively coupled to the first swivel bracket casing 164 using a fastener such as a clip, screw, nail, bolt, or interference fit structure in an embodiment. In another embodiment, the second swivel bracket casing 166 may be operatively coupled to the first swivel bracket casing 164 using a glue or other adhesive. In yet another embodiment, the second swivel bracket casing 166 may be operatively coupled to the first swivel bracket casing 164 using a welding process including an ultrasonic welding process. This ultrasonic welding process may be used whether the first swivel bracket casing 164 and the second swivel bracket casing 166 is made out of a plastic or a metal, for example.

With reference to FIGS. 3A and 3B, a manufacturer of the swivel USB adapter 158 may begin with splicing an end of the USB cable 160 to expose a portion of the coaxial cables 162. In an embodiment, the USB cable ribs 194 may be formed at an end of a sheath of the USB cable 160 with a length of the coaxial cables 162 being exposed. The length of the exposed coaxial cable 162 may be sufficient for the manufacturer to pass the coaxial cable 162 through the swivel bracket casing channel 168 formed in the first swivel bracket casing 164 and out of the coaxial cable via 196 formed in the first swivel hinge 170. Additionally, the length of the coaxial cable 162 may be sufficient for the coaxial cable 162 to exit the first swivel hinge 170 via the coaxial cable via 196 and be operatively coupled to the USB PCB 174 with additional length of the coaxial cable 162 to allow for the swiveling of the USB PCB 174 as described herein.

The manufacturer may also operatively couple the second swivel bracket casing 166 to the first swivel bracket casing 164. Again, the manufacturer may use an ultrasonic welding process, in an embodiment, to operatively couple the second swivel bracket casing 166 to the first swivel bracket casing 164.

Turning now to FIGS. 4A and 4B, FIG. 4A shows additional portions of a swivel USB adapter 158 where the USB PCB 174 has been operatively coupled to the coaxial cable 162 while FIG. 4B shows the inclusion of the second USB/PCB cover 184 in place and operatively coupled to the first swivel hinge 170 and second swivel hinge 172 in the swivel USB adapter 158 according to embodiments herein. As described herein, the coaxial cables 162 are operatively coupled to the USB PCB 174 and to any swivel USB adapter circuits (not shown) formed on the surfaces or within layers of the USB PCB 174. In the embodiments herein, the swivel USB adapter circuits 176 formed on the USB PCB 174 operatively couple the coaxial cables 162 to a first USB connector 178 formed at a first end of the USB PCB 174 and a second USB connector 180 formed at a second end of the USB PCB 174. Because the USB PCB 174, in the embodiments shown in FIGS. 4A and 4B, has the first USB connector 178 and the second USB connector 180 at opposite ends, the length of the arms of the U-shaped first swivel bracket casing 164 and second swivel bracket casing 166 may extend half way or some other portion along the total length of the first USB connector 178, USB PCB 174, and second USB connector 180 such that the user may swivel between the first USB connector 178 and the second USB connector 180 without either abutting the first swivel bracket casing 164 and second swivel bracket casing 166.

The USB PCB 174 may include a USB PCB cutout 198 formed into the USB PCB 174. The USB PCB cutout 198 may be used to pass the coaxial cables 162 out of the first swivel hinge 170 and operatively couple the coaxial cables 162 to the USB PCB 174. In an embodiment, the coaxial cables 162 may be coupled to the USB PCB 174 closer to the second USB connector 180 with electrical traces running from this connection point to the second USB connector 180 via a thin section of the first USB connector 178. This may allow for a larger footprint on the USB PCB 174 for the circuitry used to facilitate the connections at the first USB connector 178 (e.g., the USB-C type male connection in this example embodiment) while the footprint needed on the USB PCB 174 is relatively smaller for use of electrical traces on behalf the second USB connector 180 (e.g., a USB-A type male connector). The USB PCB cutout 198 may also allow for an additional length of coaxial cable 162 within the first USB/PCB cover (not shown) and second USB/PCB cover 184 so that the swivel USB adapter 158 may be swiveled by the user without putting a mechanical strain on the connection points of the coaxial cable 162 to the USB PCB 174.

FIG. 4B shows portions of the swivel USB adapter 158 with an inclusion of the second USB/PCB cover 184 formed placed under the USB PCB 174. In the embodiment shown in FIG. 4B, the second USB/PCB cover 184 includes a hemispherical hole 190 formed therein to receive the hemispherical bump 192 formed on an arm of the U-shaped first swivel bracket casing 164. As shown in FIG. 4B the hemispherical hole 190 is half of a hemispherical hole 190 with the other half of the hemispherical hole 190 being formed in a first USB/PCB cover 182 such that the coupling of the first USB/PCB cover 182 to the second USB/PCB cover 184 forms a complete hemispherical hole 190 with the combination. As described herein, the locking of the swivel USB adapter 158 through the use of the hemispherical holes 190 and hemispherical bumps 192 allows for ease of connection of the swivel USB adapter 158 to a USB port at the information handling system 100 or wired peripheral device 156 by the user.

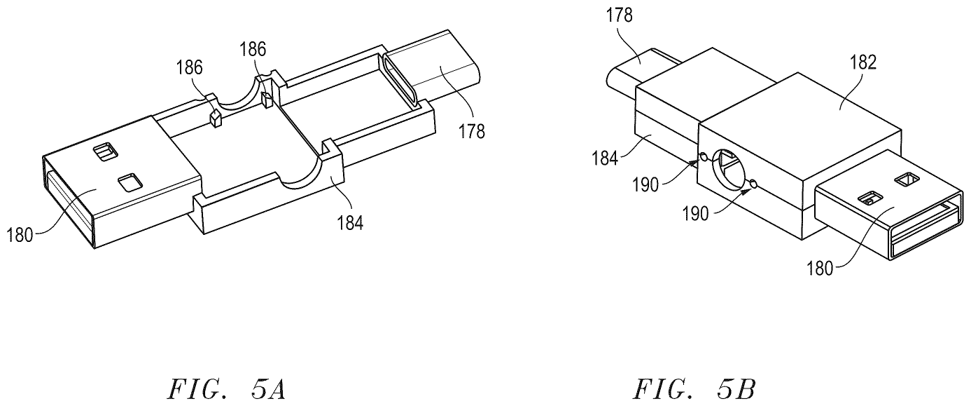

FIG. 5A is a graphic diagram of the second USB/PCB cover 184 oriented with the first USB connector 178 and second USB connector 180 to be used with the swivel USB adapter 158 according to an embodiment of the present disclosure. FIG. 5A has the USB PCB (not shown) being removed from the second USB/PCB cover 184 but the first USB connector 178 and second USB connector 180 in place.

This view of the swivel USB adapter 158 shown in FIG. 5A allows for the rotational limiter ribs 186 to be viewed. As described herein, the first USB/PCB cover 182 or second USB/PCB cover 184 may include one or more rotational limiter ribs 186 that interface with the rotational limiter hinge wheel (e.g., 188, FIGS. 3A, 3B, 4A, and 4B) to prevent over-rotation of the USB PCB (not shown) within the first swivel bracket casing and second swivel bracket casing. In an embodiment, the rotational limiter hinge wheel may be sized and the placement of the rotational limiter ribs 186 may be selected to prevent the assembly parts including the USB PCB, first USB connector 178, second USB connector 180, first USB/PCB cover (not shown), and second USB/PCB cover 184 from being rotated more than 180° or 180°+/− an additional rotational amount for some leeway in either a first rotational direction or a second rotational direction. It is appreciated that in another embodiment, the rotational limiter hinge wheel may be formed onto the housing formed by the first USB/PCB cover and second USB/PCB cover 184 while the rotational limiter ribs 186 are formed at one of the first swivel hinge or second swivel hinge to interface with that rotational limiter hinge wheel.

FIG. 5B is a graphic diagram of the first USB/PCB cover 182 and the second USB/PCB cover 184 oriented with the first USB connector 178 and second USB connector 180 for use with the swivel USB adapter 158 according to an embodiment of the present disclosure. FIG. 5B shows the first USB/PCB cover 182 and second USB/PCB cover 184 forming a housing for the USB PCB (not shown) as well as the swivel USB adapter circuits (not shown) formed thereon for the swivel USB adapter 158.

FIG. 5B also shows the hemispherical holes 190 formed into the exterior surfaces of the first USB/PCB cover 182 and second USB/PCB cover 184. As described herein, in an embodiment, each of the first USB/PCB cover 182 and second USB/PCB cover 184 may have half of a hemispherical hole 190 formed into the exterior such that when the first USB/PCB cover 182 and second USB/PCB cover 184 are coupled together. Again, the hemispherical holes 190 may interface with hemispherical bumps (not shown) in order to lock the orientation of the USB PCB (not shown), first USB/PCB cover 182, second USB/PCB cover 184 assembly in place relative to the first swivel bracket casing (not shown) and second swivel bracket casing (not shown) assembly. During operation and when a user rotates or swivels the USB PCB, first USB/PCB cover 182, and second USB/PCB cover 184 assembly, the hemispherical bumps may be forced into the hemispherical holes 190 in order to lock the USB PCB, first USB connector 178, and second USB connector 180 assembly in place. This locking may also provide haptic feedback to the user indicating that the USB PCB, first USB connector 178, and second USB connector 180 assembly is locked into place.

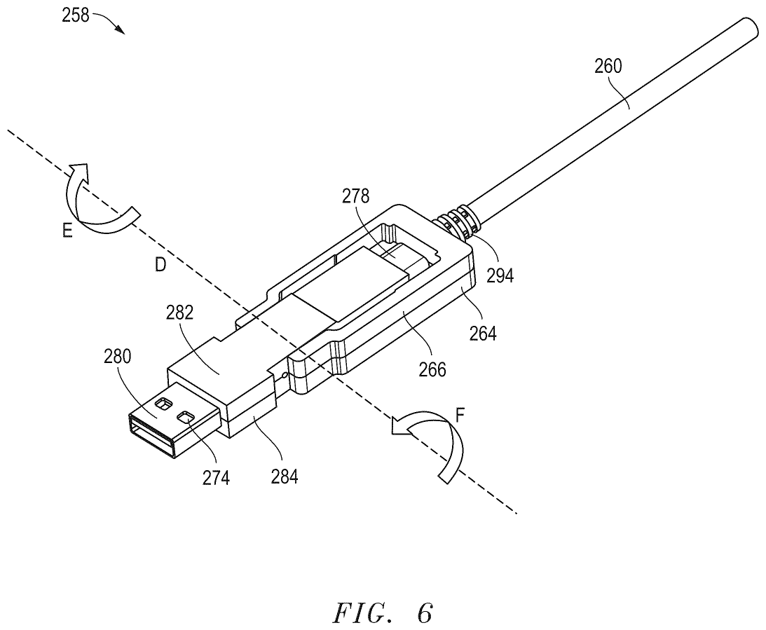

FIGS. 6 through 9B show a second embodiment of a swivel USB adapter 258. Turning to FIG. 6, FIG. 6 is a graphic diagram illustrating a swivel USB adapter 258 according to another embodiment of the present disclosure. As described herein, the swivel universal serial bus adapter 258 may be a relatively thinner version of the swivel universal serial bus adapter 258 than that described and shown in FIG. 2, for example. This thinner design may be longer and allow for more surface area that the user may interact with in order to insert the first USB connector 278 and second USB connector 280 into their respective ports. Additionally, a thinner design may also allow for a physical width footprint for the swivel USB adapter 258 around respective USB ports to be reduced such that multiple swivel USB adapters 258 may be used with closely situated USB ports on an information handling system or docking station. Additionally, the thinner design of the swivel universal serial bus adapter 258 shown in FIGS. 6 through 9B include a thinner USB PCB (not shown) that may require a thinner portion of the USB PCB to route the swivel USB adapter circuits (not shown) to the first USB connector 278 as described herein.

In an embodiment, a wired peripheral device for connection with the swivel USB adapter 258 shown in FIG. 6 may be similar to the wired peripheral device described in connection with FIG. 1. As described herein, the swivel USB adapter 258 may be operatively coupled to a terminal end of a USB cable 260. The USB cable 260 may be directly coupled to a wired peripheral device (not shown) in an embodiment. In another embodiment, the USB cable 260 may include another swivel USB adapter 258 formed at another end of the USB cable 260 such that a first swivel USB adapter 258 is formed at a first end of the USB cable 260 and a second swivel USB adapter 258 is formed at a second end of the USB cable 260.

The USB cable 260 may include one or more USB cable ribs 294. In an embodiment, these USB cable ribs 294 may be used to provide material support to the USB cable 260 such that constant bending of the USB cable 260 at these USB cable ribs 294 does not damage the coaxial cables (not shown) within the USB cable 260 are not damaged. Additionally, as described herein, one or more of USB cable ribs 294 may be used to interface, mechanically, with the first swivel bracket casing 264 and second swivel bracket casing 266 to secure the USB cable 260 to the swivel USB adapter 258. In an embodiment, a USB cable rib 294 may be placed within a hole formed in the first swivel bracket casing 264 and second swivel bracket casing 266 such that the USB cable 260 cannot be pulled out from the first swivel bracket casing 264 and second swivel bracket casing 266.

FIG. 6 also shows portions of the swivel USB adapter 258 including a first USB/PCB cover 282 and second USB/PCB cover 284 that form a USB/PCB housing that houses a USB PCB 274 with its swivel USB adapter circuits (not shown) as well as portions of the first USB connector 278 and second USB connector 280 according to an embodiment. As described herein, either of the first USB/PCB cover 282, second USB/PCB cover 284, or some combination may include hemispherical holes (not shown) formed into a side surface of the either the first USB/PCB cover 282 or second USB/PCB cover 284. These hemispherical holes may interface with one or more hemispherical bumps (not sown) formed on an interior surface of either the first swivel bracket casing 264 or second swivel bracket casing 266. Again, during operation and when a user rotates or swivels the USB PCB 274, first USB/PCB cover 282, and second USB/PCB cover 284 assembly, the hemispherical bumps may be forced into the hemispherical bumps in order to lock the USB PCB 274, first USB connector 278, and second USB connector 280 assembly in place. This locking may also provide haptic feedback to the user indicating that the USB PCB 274, first USB connector 278, and second USB connector 280 assembly is locked into place.

FIG. 6 shows that two different USB connectors have been implemented in this example embodiment. In the example shown in FIG. 6, the first USB connector 278 is shown as a USB-C type male connector that is in a closed position but may be used to operatively couple a wired peripheral device or the USB cable 260 into a USB-C type port on a wired peripheral device or information handling system. Additionally, FIG. 6 shows the second USB connector 280 is a USB-A type male connector that is in a deployed position and may be used to operatively couple a wired peripheral device or the USB cable 260 into a USB-A port on a wired peripheral device or information handling system. It is appreciated, however, that the first USB connector 278 may be any type of USB connector and the second USB connector 280 may be any type of connector such as a USB Standard-A connector, a USB Standard-B connector, a USB Mini-A connector, a USB Mini-AB connector, a USB Mini-B connector, a USB Micro-A connector, a USB Micro-AB connector, a USB Micro-B connector, USB Type-C, among others. The swivel USB adapter 258 may, therefore, provide for a plurality of different types of USB connectors being used as the first USB connector 278 and second USB connector 280 that may span over a technology transition period from a first USB type of connector to a second USB type of connector.

FIG. 6 also shows potential directions of rotation (e.g., arrow “E” and arrow “F”) and an axis on which the assembly of the USB PCB 274, first USB/PCB cover 282, and second USB/PCB cover 284 may swivel or rotate about. For example, the user may rotate, about the axis “D,” the assembly of the USB PCB 274, first USB/PCB cover 282, and second USB/PCB cover 284 in direction “E” to cause the first USB connector 278 to face forward in a deployed position thereby swapping locations with the second USB connector 280. With the first USB connector 278 in its new position, the user may rotate, about the axis “B,” the assembly of the USB PCB 274, first USB/PCB cover 282, and second USB/PCB cover 284 in direction “F” to return the second USB connector 280 to its original position.

As described herein, the coaxial cables (not shown) are operatively coupled to the USB PCB 274. However, over rotation of the USB PCB 274 in a single rotation direction multiple times (e.g., arrow “E” or “F”) may cause the coaxial cable to be torn from those connections to the USB PCB 274. In order to prevent this, in an embodiment, one of the first swivel hinge (not shown) or second swivel hinge (not shown) may include a rotational limiter hinge wheel (not shown) that interacts with one or more rotational limiter ribs (not shown) formed within the USB/PCB housing (e.g., the first USB/PCB cover 282 and second USB/PCB cover 284). The interaction between the rotational limiter hinge wheel and one or more rotational limiter ribs may allow for a 180° swivel or with some additional rotation amount of the assembly of the USB PCB 274, first USB/PCB cover 282, and second USB/PCB cover 284 in order to prevent the over rotation described herein.

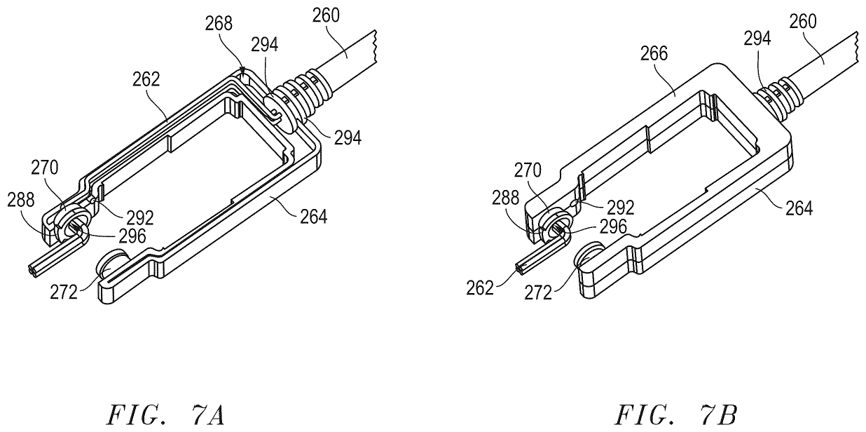

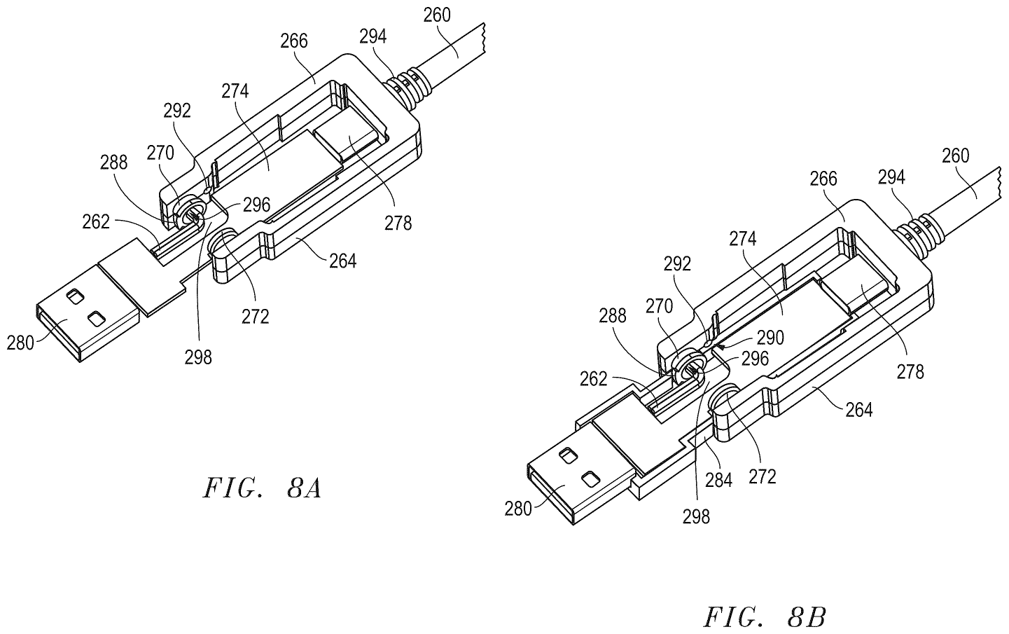

FIGS. 7A, 7B, 8A, and 8B each show portions of a swivel USB adapter 258 described herein. FIG. 7A is a graphic diagram of a USB cable 260 including a coaxial cable 262 interfacing with a first swivel bracket casing 264 of a swivel USB adapter 258 according to an embodiment of the present disclosure. Additionally, FIG. 7B is a graphic diagram of the USB cable 260 including the coaxial cable 262 interfacing with the first swivel bracket casing 264 and a second swivel bracket casing 266 of a swivel USB adapter 258 according to an embodiment of the present disclosure. Further, FIG. 8A is a graphic diagram of the USB cable 260 including the coaxial cable 262 interfacing with the first swivel bracket casing 264 and a second swivel bracket casing 266 and with a USB PCB 274 having a first USB connector 278 and a second USB connector 280 of a swivel USB adapter 258 according to an embodiment of the present disclosure. Still further, FIG. 8B is a graphic diagram of the USB cable 260 including the coaxial cable 262 interfacing with the first swivel bracket casing 264 and a second swivel bracket casing 266 and with a USB PCB 274 showing a second USB/PCB cover 284 and having a first USB connector 278 and a second USB connector 280 housed in the second USB/PCB cover 284 of a swivel USB adapter 258 according to an embodiment of the present disclosure.

Turning to FIG. 7A, FIG. 7A shows an operative coupling of the USB cable 260 to the first swivel bracket casing 264. As described herein, the USB cable 260 may include one or more USB cable ribs 294. In the embodiment shown in FIG. 3, an outer surface of the first swivel bracket casing 264 may be placed between one USB cable rib 294 and another USB cable rib 294 such that the USB cable 260 is affixed, mechanically, to the first swivel bracket casing 264. Thus, the inclusion of the USB cable ribs 294 provides both a physical structural support to the USB cable 260 at the location where the USB cable 260 may be most bent or interface with the swivel bracket casing 264, 266 as well as provide for a physical structure to secure the USB cable 260 to the first swivel bracket casing 264 and the second swivel bracket casing 266 as shown in FIG. 7B.

As shown in FIG. 7A, the coaxial cable 262 of the USB cable 260 may be routed through a swivel bracket casing channel 268 formed within the first swivel bracket casing 264. The swivel bracket casing channel 268 may be routed along one of the arms of the U-shaped first swivel bracket casing 264 and out of a coaxial cable via 296 formed at the first swivel hinge 270 of the first swivel bracket casing 264. It is appreciated, however, that the coaxial cable 262 may be routed through the other arm of the U-shaped first swivel bracket casing 264 and out of a coaxial cable via 296 formed at the second swivel hinge 272.

FIGS. 7A and 7B also show a hemispherical bump 292 formed on an internal surface of the first arm of the U-shaped first swivel bracket casing 264 or second swivel bracket casing 266, or some combination. It is appreciated that the hemispherical bump 292 or another hemispherical bump 292 may be formed on the interior surface of the second arm of the first swivel bracket casing 264. Alternatively, the hemispherical bumps 292 may be formed on an internal surface of the first arm of the U-shaped second swivel bracket casing 266 and or on an internal surface of the second arm of the U-shaped second swivel bracket casing 266, or both.

FIGS. 7A and 7B both show a rotational limiter hinge wheel 288 formed on the first swivel hinge 270. It is appreciated that, additionally or alternatively, the rotational limiter hinge wheel 288 may be formed on the second swivel hinge 272 in some embodiments. As described herein, the rotational limiter hinge wheel 288 may interface with one or more rotational limiter ribs (not shown) formed into an interior surface of the first USB/PCB cover 282 and/or second USB/PCB cover 284 to limit the degree or rotation of the USB PCB (not shown). In an embodiment, the rotational limiter hinge wheel 288 may be sized and the placement of the rotational limiter ribs may be selected to prevent the assembled parts including the USB PCB, first USB connector (not shown), second USB connector (not shown), first USB/PCB cover (not shown), and second USB/PCB cover (not shown) from being rotated more than 180° in either a first rotational direction (e.g., arrow “E,” FIG. 6) or a second rotational direction (e.g., arrow “F,” FIG. 6) or 180°+/− some additional rotation amount for leeway such as +/−5° or 10° or any amount of additional leeway rotation. The hemispherical bump 292 may stop or lock rotation to a desired position such as 180° in some embodiments. It is appreciated that in another embodiment, the rotational limiter hinge wheel 288 may be formed onto the housing formed by the first USB/PCB cover and second USB/PCB cover while the rotational limiter ribs are formed at one of the first swivel hinge 270 or second swivel hinge 272 to interface with that rotational limiter hinge wheel.

Turning to FIG. 7B, the second swivel bracket casing 266 is shown to be operatively coupled to the first swivel bracket casing 264 thereby forming a swivel bracket housing used to securely house the coaxial cables 262 in embodiments herein. In an embodiment, the second swivel bracket casing 266 may also include a swivel bracket casing channel 268 that mirrors the swivel bracket casing channel 268 formed into the first swivel bracket casing 264 shown in FIG. 3B to accommodate the placement of the coaxial cables 262 being passed through the first arm of the U-shaped swivel bracket housing.

By coupling the second swivel bracket casing 266 to the first swivel bracket casing 264, the housing of the first swivel bracket casing 264 and second swivel bracket casing 266 secure the USB cable 260 to the housing of the swivel bracket housing such that the USB cable 260 cannot be pulled from the swivel bracket housing. As described herein, the second swivel bracket casing 266 may be operatively coupled to the first swivel bracket casing 264 using a fastener such as a screw, nail, or bolt in an embodiment. In another embodiment, the second swivel bracket casing 266 may be operatively coupled to the first swivel bracket casing 264 using a interference fit of interference fit structures or an adhesive such as a glue. In yet another embodiment, the second swivel bracket casing 266 may be operatively coupled to the first swivel bracket casing 264 using a welding process including an ultrasonic welding process. This ultrasonic welding process may be used whether the first swivel bracket casing 264 and the second swivel bracket casing 266 is made out of a plastic or a metal, for example.

With reference to FIGS. 7A and 7B, a manufacturer of the swivel USB adapter 258 may begin with splicing an end of the USB cable 260 to expose a portion of the coaxial cables 262. In an embodiment, the USB cable ribs 294 may be formed at an end of a sheath of the USB cable 260 with a length of the coaxial cables 262 being exposed. The length of the exposed coaxial cable 262 may be sufficient for the manufacturer to pass the coaxial cable 262 through the swivel bracket casing channel 268 formed in the first swivel bracket casing 264 and out of the coaxial cable via 296 formed in the first swivel hinge 270. Additionally, the length of the coaxial cable 262 may be sufficient for the coaxial cable 262 to exit the first swivel hinge 270 via the coaxial cable via 296 and be operatively coupled to the USB PCB 274 with additional length of the coaxial cable 262 to allow for the swiveling of the USB PCB 274 as described herein.

The manufacturer may also operatively couple the second swivel bracket casing 266 to the first swivel bracket casing 264. Again, the manufacturer may use an ultrasonic welding process, in an embodiment, to operatively couple the second swivel bracket casing 266 to the first swivel bracket casing 264.

Turning now to FIGS. 8A and 8B, FIG. 8A shows the USB PCB 274 has been operatively coupled to the coaxial cable 262 while FIG. 8B shows the inclusion of the second USB/PCB cover 284 in place and operatively coupled to the first swivel hinge 270 and second swivel hinge 272. As described herein, the coaxial cables 262 are operatively coupled to the USB PCB 274 and to any swivel USB adapter circuits (not shown) formed on the surfaces of the USB PCB 274 to allow the USB cable to connect to both the first USB connector 278 and the second USB connector 280 in embodiments. In the embodiments herein, the swivel USB adapter circuits 276 formed on the USB PCB 274 operatively couple the coaxial cables 262 to a first USB connector 278 formed at a first end of the USB PCB 274 and a second USB connector 280 formed at a second end of the USB PCB 274. Because the USB PCB 274, in the embodiments shown in FIGS. 8A and 8B, is elongated with the first USB connector 278 and the second USB connector 280 at opposite ends, the length of the arms of the U-shaped first swivel bracket casing 264 and second swivel bracket casing 266 may extend half way along the total length of the first USB connector 278, USB PCB 274, and second USB connector 280 such that the user may swivel between the first USB connector 278 and the second USB connector 280 without either abutting the first swivel bracket casing 264 and second swivel bracket casing 266. In an example embodiment, the length of the USB PCB 274 and the arms of the U-shaped swivel bracket casings 264, 266 may be longer than the embodiments shown in FIGS. 2-5B, but this allows for the swivel USB adapter 258 to be thinner as well.

The USB PCB 274 may include a USB PCB cutout 298 formed into the USB PCB 274. The USB PCB cutout 298 may be used to pass the coaxial cables 262 out of the first swivel hinge 270 and operatively couple the coaxial cables 262 to the USB PCB 274 as well as accommodate the thinner swivel USB adapter 258. In an embodiment, the coaxial cables 262 may be coupled to the USB PCB 274 closer to the second USB connector 280 with electrical traces running from this connection point to the second USB connector 280 via a thin section of the first USB connector 278. This may cause a longer footprint on the USB PCB 274 for the circuitry used to facilitate the connections at the first USB connector 278 (e.g., the USB-C type male connection in this example embodiment) while the footprint needed on the USB PCB 274 is relatively thinner for use of electrical traces on behalf the second USB connector 280 (e.g., a USB-A type male connector). As described herein, the thinner portion of the USB PCB 274 may be relatively thinner than that shown in, for example, FIG. 4B. This is a result of having the USB PCB 274 made longer and thinner so that the swivel USB adapter 258 has less of a physical footprint when coupled to a USB port. The USB PCB cutout 298 may also allow for an additional length of coaxial cable 262 within the first USB/PCB cover (not shown) and second USB/PCB cover 284 so that the swivel USB adapter 258 may be swiveled by the user without putting a mechanical strain on the connection points of the coaxial cable 262 to the USB PCB 274.

FIG. 8B shows that inclusion of the second USB/PCB cover 284 formed placed under the USB PCB 274. In the embodiment shown in FIG. 4B, the second USB/PCB cover 284 includes a hemispherical hole 290 formed therein to receive the hemispherical bump 292 formed on an arm of the U-shaped first swivel bracket casing 264. As shown in FIG. 4B the hemispherical hole 290 is half of a hemispherical hole 290 with the other half of the hemispherical hole 290 being formed in a first USB/PCB cover 282 such that the coupling of the first USB/PCB cover 282 to the second USB/PCB cover 284 forms a complete hemispherical hole 290 with the combination. As described herein, the locking of the swivel USB adapter 258 through the use of the hemispherical holes 290 and hemispherical bumps 292 allows for ease of connection of the swivel USB adapter 258 to a USB port at the information handling system 200 or wired peripheral device 256 by the user.

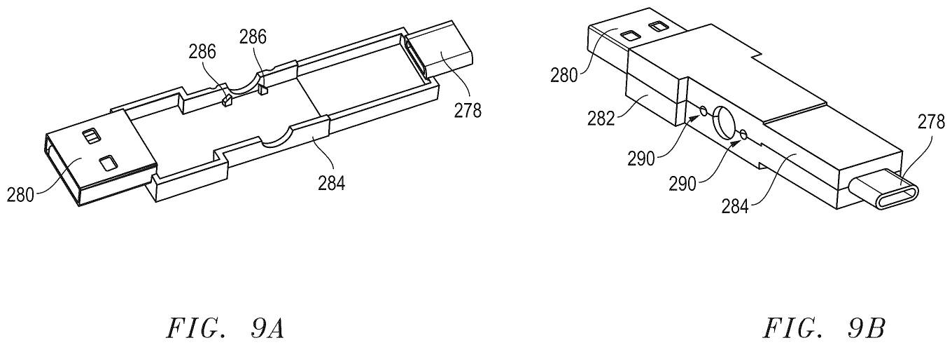

FIG. 9A is a graphic diagram of the second USB/PCB cover 284 oriented with the first USB connector 278 and second USB connector 280 of a swivel USB adapter 258 according to an embodiment of the present disclosure. FIG. 9A shows the USB PCB (not shown) removed from the second USB/PCB cover 284 but the first USB connector 278 and second USB connector 280 in place.

This view of the swivel USB adapter 258 shown in FIG. 9A allows for the rotational limiter ribs 286 to be viewed. As described herein, the first USB/PCB cover 282 or second USB/PCB cover 284 may include one or more rotational limiter ribs 286 that interface with the rotational limiter hinge wheel (e.g., 288, FIGS. 7A, 7B, 8A, and 8B) to prevent over-rotation of the USB PCB (not shown) within the first swivel bracket casing and second swivel bracket casing. In an embodiment, the rotational limiter hinge wheel may be sized and the placement of the rotational limiter ribs 186 may be selected to prevent the assembly parts including the USB PCB, first USB connector 278, second USB connector 280, first USB/PCB cover (not shown), and second USB/PCB cover 284 from being rotated more than 180° or 180°+/− some additional rotation amount in either a first rotational direction or a second rotational direction. It is appreciated that in another embodiment, the rotational limiter hinge wheel may be formed onto the housing formed by the first USB/PCB cover and second USB/PCB cover 284 while the rotational limiter ribs 286 are formed at one of the first swivel hinge or second swivel hinge to interface with that rotational limiter hinge wheel.

FIG. 9B is a graphic diagram of the first USB/PCB cover 282 and the second USB/PCB cover 284 oriented with the first USB connector 278 and second USB connector 280 of a swivel USB adapter 258 according to an embodiment of the present disclosure. FIG. 9B shows the first USB/PCB cover 282 and second USB/PCB cover 284 forming a housing for the USB PCB (not shown) as well as the swivel USB adapter circuits (not shown) formed thereon.

FIG. 9B also shows the hemispherical holes 290 formed into the exterior surfaces of the first USB/PCB cover 282 and second USB/PCB cover 284. As descried herein, in an embodiment, each of the first USB/PCB cover 282 and second USB/PCB cover 284 may have half of a hemispherical hole 290 formed into the exterior such that when the first USB/PCB cover 282 and second USB/PCB cover 284 are coupled together. Again, the hemispherical holes 290 may interface with hemispherical bumps (not shown) in order to lock the orientation of the USB PCB (not shown), first USB/PCB cover 282, second USB/PCB cover 284 assembly in place relative to the first swivel bracket casing (not shown) and second swivel bracket casing (not shown) assembly. During operation and when a user rotates or swivels the USB PCB, first USB/PCB cover 282, and second USB/PCB cover 284 assembly, the hemispherical bumps may be forced into the hemispherical holes 290 in order to lock the USB PCB, first USB connector 278, and second USB connector 280 assembly in place. This locking may also provide haptic feedback to the user indicating that the USB PCB, first USB connector 278, and second USB connector 280 assembly is locked into place.

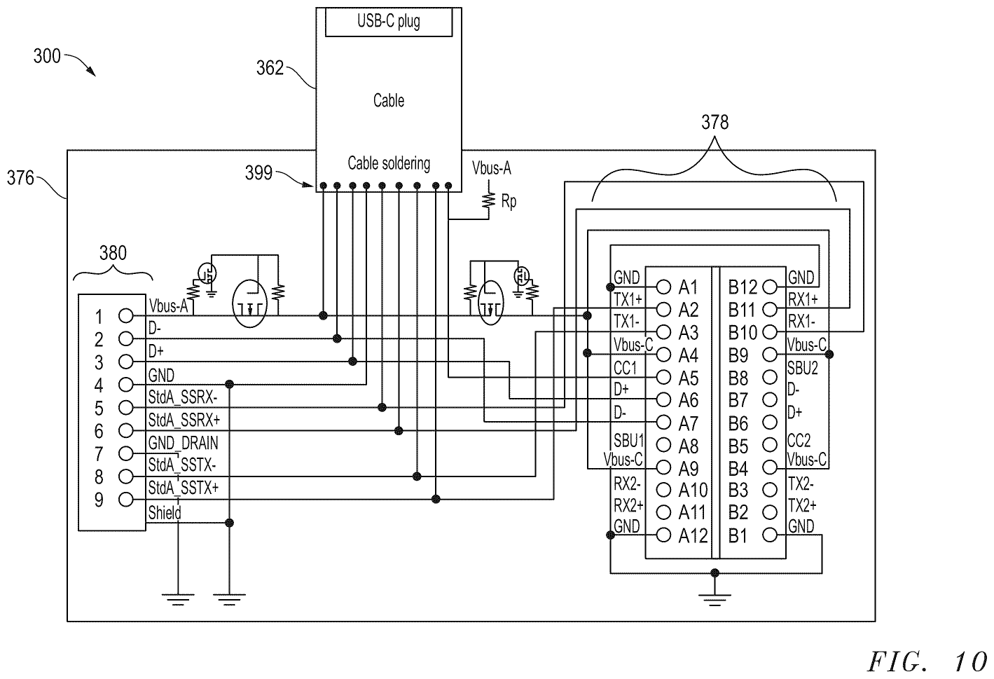

FIG. 10 is a circuit diagram 300 of swivel USB adapter circuits 376 according to an embodiment of the present disclosure. As described herein, these swivel USB adapter circuits 376 may be formed onto the surfaces of the USB PCB (not shown) within the swivel USB adapter. The swivel USB adapter circuits 376 includes a first USB connector 378 portion, a second USB connector 380 portion, and an interface to operatively couple the coaxial cable 362 to both the first USB connector 378 and second USB connector 380.

In an embodiment, the coaxial cable 362 may be operatively coupled to the USB PCB via a plurality of different coaxial cable soldering points 399. These plurality of different coaxial cable soldering points 399 may correspond to a power (Vbus) cable, a first data cable (D−), a second data cable (D+), a ground cable of a USB cable, a negative SuperSpeed receiver cable (StdB_SSRX−), a positive SuperSpeed receiver (StdB_SSRX+) cable, a ground drain cable (GND_DRAIN), a negative SuperSpeed transmitter (StdA_SSTX−) cable, and a positive SuperSpeed transmitter (StdA_SSTX+) cable. Thus, these coaxial cable soldering points 399 couple these coaxial cables 362 to the appropriate electrical leads in each of the first USB connector 378 and second USB connector 380.

The operative coupling of the coaxial cables to the second USB connector 380 may include connecting the electrical leads from the coaxial cable soldering points 399 to the appropriate respective leads at the second USB connector 380. In the example embodiment shown in FIG. 10, the second USB connector 380 is a USB-A type connector with a direct one-to-one connection to the coaxial cables 362.

Because of the additional pins within the USB-C type connector of the first USB connector 378, the power (Vbus), a first data (D−), a second data (D+), and ground cables are doubled and reflected on opposite serial connector lines. Additionally, other pins may be included within the USB-C type connector that include additional power and ground pins usually provided for carrying more power (e.g., 5 Amps) to the USB-C type connector. In an embodiment, however, these additional pins remain unused. However, the circuit diagram 300 does not include, for example, a hub integrated circuit so that the total physical footprint of the electrical circuits on the USB PCB is reduced in order to reduce the overall physical footprint of the swivel USB adapter described herein.

The steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. A swivel universal serial bus (USB) adapter comprising:
a USB cable comprising a coaxial cable to transmit power and data between a wired peripheral device and a USB port;
a printed circuit board (PCB) to operatively couple the coaxial cable to a first USB connector formed at a first end of the PCB and a second USB connector formed at a second end of the PCB, the PCB including a PCB cutout to receive the coaxial cable from a swivel hinge of a swivel bracket casing and to the PCB;
the swivel bracket casing including swivel bracket casing channel and the swivel hinge to pass the coaxial cable through to the PCB via the PCB cutout; and
a first USB/PCB cover and a second USB/PCB cover to enclose the PCB, where the first USB/PCB cover and the second USB/PCB rotate on the swivel hinge such that the first USB connector and second USB connector may be switched.

2. The swivel USB adapter of claim 1, wherein the first USB connector is a USB-A connector and the second USB connector is a USB-C connector.

3. The swivel USB adapter of claim 1 further comprising:
one or more rotation limiter ribs formed on the second USB/PCB cover to interact with a rotation limiter hinge wheel formed on the swivel bracket casing to limit the rotation of the PCB with the first USB connector formed at a first end of the PCB and a second USB connector formed at a second end of the PCB from rotating beyond a limit about the swivel hinge in a single direction.

4. The swivel USB adapter of claim 1 further comprising:
one or more hemispherical holes formed on the first USB/PCB cover to engage with hemispherical bumps formed on the swivel bracket casing to lock the PCB with the first USB connector and the second USB connector in a first 180° orientation for use of the first USB connector and to provide haptic feedback to a user of the USB adapter indicating that the PCB with the first USB connector and second USB connector is locked in the first 180° orientation.

5. The swivel USB adapter of claim 4 further comprising:
the one or more hemispherical holes formed on the first USB/PCB cover to engage with hemispherical bumps formed on the swivel bracket casing to lock the PCB with the first USB connector and the second USB connector in a second 180° orientation for use of the second USB connector and to provide haptic feedback to a user of the USB adapter indicating that the PCB with the first USB connector and second USB connector is locked in the second 180° orientation.

6. The swivel USB adapter of claim 1, wherein the swivel bracket casing includes a first swivel bracket casing and a second swivel bracket casing to encase the coaxial cable into the first swivel bracket casing channel.

7. The swivel USB adapter of claim 1 further comprising:
the PCB including electrical circuit connections that pass the USB lines of the coaxial cable between the first USB connector and second USB connector such that either the first USB connector or the second USB connector operates depending on rotation of the swivel USB adapter.

8. A swivel universal serial bus (USB) adapter comprising:
a USB cable comprising a cable jacket and a coaxial cable to transmit power and data between a wired peripheral device and a USB port;
a printed circuit board (PCB) to operatively couple the coaxial cable to a first USB connector formed at a first end of the PCB and a second USB connector formed at a second end of the PCB;
a swivel bracket casing including a swivel bracket casing channel and a swivel hinge to pass the coaxial cable through to the PCB; and
a first USB/PCB cover and a second USB/PCB cover to enclose the PCB, where the first USB/PCB cover and the second USB/PCB rotate on the swivel hinge such that the first USB connector and second USB connector may be switched.

9. The swivel USB adapter of claim 8, wherein the first USB connector is a USB-A connector and the second USB connector is a USB-C connector.

10. The swivel USB adapter of claim 8 further comprising:
one or more hemispherical holes formed on the first USB/PCB cover to engage with hemispherical bumps formed on the swivel bracket casing to lock the PCB with the first USB connector and second USB connector into a position to utilize the first USB connector or the second USB connector and to provide haptic feedback to a user of the USB adapter indicating that the PCB with the first USB connector and second USB connector is locked in the position.

11. The swivel USB adapter of claim 8, wherein the swivel bracket casing includes a first swivel bracket casing and a second swivel bracket casing to encase the coaxial cable into the first swivel bracket casing channel.

12. The swivel USB adapter of claim 8 further comprising:
the PCB including a PCB cutout to pass the coaxial cable out of the swivel hinge and to the PCB and allow for rotation of the PCB.

13. The swivel USB adapter of claim 8 further comprising:
one or more rotation limiter ribs formed on the second USB/PCB cover to interact with a rotation limiter hinge wheel formed on the swivel bracket casing to limit the rotation of the PCB with the first USB connector formed at a first end of the PCB and a second USB connector formed at a second end of the PCB from rotating more than 180° about the swivel hinge in a single direction.

14. A swivel universal serial bus (USB) adapter comprising:
a USB cable comprising a coaxial cable to transmit power and data between a wired peripheral device and a USB port;
a printed circuit board (PCB) to operatively couple the coaxial cable to a first USB connector formed at a first end of the PCB and a second USB connector formed at a second end of the PCB;
a swivel bracket casing, the swivel bracket casing comprising swivel bracket casing channel and a swivel hinge to pass the coaxial cable through to the PCB; and
a first USB/PCB cover and a second USB/PCB cover to enclose the PCB and rotatable on the swivel hinge between a first position for the first USB connector and a second position for the second USB connector.

15. The swivel USB adapter of claim 14, wherein the first USB connector is a USB-A connector and the second USB connector is a USB-C connector.

16. The swivel USB adapter of claim 14 further comprising:
one or more rotation limiter ribs formed on the second USB/PCB cover to interact with a rotation limiter hinge wheel formed on the swivel bracket casing to limit the rotation of the PCB with the first USB connector formed at a first end of the PCB and a second USB connector formed at a second end of the PCB from rotating more than 180° about the swivel hinge in a single direction.

17. The swivel USB adapter of claim 14 further comprising:
one or more hemispherical holes formed on the first USB/PCB cover to engage with hemispherical bumps formed on the swivel bracket casing to lock the PCB with the first USB connector and second USB connector into the first position to utilize the first USB connector or the second position to utilize the second USB connector and to provide haptic feedback to a user of the USB adapter indicating that the PCB with the first USB connector and second USB connector is locked in the first position.

18. The swivel USB adapter of claim 14, wherein the swivel bracket casing includes a first swivel bracket casing portion and a second swivel bracket casing portion to encase the coaxial cable into the first swivel bracket casing channel.

19. The swivel USB adapter of claim 15 further comprising:
the PCB including a PCB cutout to pass the coaxial cable out of the swivel hinge and to the PCB and allow for rotation of the PCB.

20. The swivel USB adapter of claim 15 further comprising:
the USB cable operatively coupled to the swivel bracket casing via a cable jacket of the USB cable.
